(19) United States
(12) Patent Application Publication
(10) Pub. No.: US 2007/0216381 A1
(43) Pub. Date: Sep. 20, 2007

(54) Linear regulator circuit

(75) Inventors: Chikara Tsuchiya, Kasugai (JP); Eiji Nishimori, Kasugai (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/499,718

(22) Filed: Aug. 7, 2006

(30) Foreign Application Priority Data
Mar. 16, 2006 (JP) 2006-073564

(51) Int. Cl. G05F 1/00

(52) U.S. Cl. 323/273

(57) ABSTRACT

A linear regulator circuit for suppressing power supply noise that propagates to an output voltage. An LDO circuit functioning as the linear regulator circuit is provided with an output transistor including a source for receiving input voltage, a drain for outputting the output voltage, and a control terminal. An error amplifier powered by the input voltage generates a control voltage for controlling the output transistor based on a potential difference between a feedback voltage, which corresponds to the output voltage, and a reference voltage. A first capacitor and a resistor are connected in series between the source of the output transistor and an output terminal of the error amplifier.

### CROSS-REFERENCE TO RELATED APPLICATIONS

This application is based upon and claims the benefit of priority from the prior Japanese Patent Application No. 2006-073564, filed on Mar. 16, 2006, the entire contents of which are incorporated herein by reference.

### BACKGROUND OF THE INVENTION

The present invention relates to a linear regulator circuit, and more particularly, to a low drop out (LDO) circuit, which is a type of linear regulator circuit that generates a constant voltage.

An LDO circuit, powered by input voltage, generates a constant voltage that is close to the input voltage. The LDO circuit detects output voltage of an output transistor with an error amplifier and controls the output transistor so as to compensate for fluctuations in the output voltage. Fluctuations in the output voltage that are caused by fluctuations in the input voltage must be accurately suppressed in the LDO circuit.

FIG. 1 is a schematic circuit diagram of an LDO circuit 100 in the prior art. The error amplifier 1 is supplied with and powered by input voltage Vi, which is also the source of an output transistor Tr1, which is configured by a P-channel MOS transistor. The output signal of the error amplifier 1 is provided to the gate of the output transistor Tr1.

Resistors R1 and R2 are connected in series between the drain of the output transistor Tr1 and ground GND. A node N1 located between the resistors R1 and R2 is connected to a positive input terminal of the error amplifier 1. A reference voltage e1 is supplied to a negative input terminal of the error amplifier 1.

The drain of the output transistor Tr1 is connected to an output terminal To, from which output voltage Vo is output. A capacitor C1 is connected between the output terminal To and the ground GND.

In such a configuration, when the output voltage Vo decreases and the potential at node N1 decreases, the error amplifier 1 functions to decrease the gate voltage of the output transistor Tr1. This reduces the on-resistance of the output transistor Tr1 and increases the output voltage Vo. As the gate voltage of the output transistor Tr1 increases and the potential at node N1 increases, the error amplifier 1 functions to increase the output voltage Vo. Consequently, the on-resistance of the output transistor Tr1 is increased and the output voltage Vo is decreased.

The reference voltage e1 is a stable voltage that is subtly affected fluctuations in the input voltage Vi. The capacitor C1 suppresses fluctuations of the output voltage Vo caused by a load connected to the output terminal To.

In such a configuration, the fluctuations in the output voltage Vo is suppressed by the error amplifier 1 and the capacitor C1, and the output voltage Vo is generated to minimize the voltage decrease from the input voltage Vi. Low frequency fluctuations in the output voltage Vo are suppressed by the error amplifier 1, and high frequency fluctuations are suppressed by the capacitor C1.

FIG. 2 is a schematic circuit diagram of the error amplifier 1 shown in FIG. 1. The reference voltage e1 and the potential at node N1 are supplied to transistors Tr2 and Tr3, respectively. Transistors Tr4 and Tr5 function as a current mirror based on the drain current of the transistor Tr2, and transistors Tr6 and Tr7 functions as a current mirror based on the drain current of the transistor Tr5.

Transistors Tr8 and Tr9 function as a current mirror based on the drain current of the transistor Tr3. The drain of each of the transistors Tr7 and Tr9 is connected to the gate of the output transistor Tr1.

In such a configuration, the drain current of the transistor Tr7 decreases as the potential at node N1 decreases based on the reference voltage e1. Further, the drain current of the transistor Tr7 increases as the potential at node N1 increases based on the reference voltage e1. The drain current of the transistor Tr9 increases as the potential at node N1 decreases, and the drain current of the transistor Tr9 decreases as the potential at node N1 increases.

Accordingly, the error amplifier 1 functions as a positive phase amplifier for increasing the gate potential of the output transistor Tr1 as the output voltage Vo increases and for decreasing the gate potential of the output transistor Tr1 as the output voltage Vo decreases.

FIG. 3 is a schematic circuit diagram of another LDO circuit 200 in the prior art. The LDO circuit 200 includes an error amplifier 2, which functions as a reverse phase amplifier, and a reverse phase amplifier 3, which is arranged between the error amplifier 2 and an output transistor Tr1. The potential at node N1 and the gate potential of the output transistor Tr1 has a positive phase.

FIG. 4 is a schematic circuit diagram of the error amplifier 2 and the reverse phase amplifier 3 of FIG. 3. The error amplifier 2 and the reverse phase amplifier 3 operate in reverse phases so that the LDO circuit 200 functions as a positive phase amplifier. The capacitor C2 shown in FIG. 4 suppresses high frequency fluctuations in the output voltage Vo and improves the response of the error amplifier 2.

### SUMMARY OF THE INVENTION

In the LDO circuit 100 shown in FIG. 2, when the input voltage Vi fluctuates, the voltage between the source and drain of the transistor Tr7, which is in the output stage of the error amplifier 1, fluctuates. This causes the voltage to fluctuate between the source and the gate of the output transistor Tr1.

The fluctuation of the input voltage Vi causes the output voltage Vo to fluctuate. This lowers the power supply rejection ratio (PSRR).

The capacitor C1 contributes to suppressing high frequency fluctuations in the output voltage Vo, and the error amplifier 1 contributes to suppressing low frequency fluctuations in the output voltage Vo. However, intermediate frequency fluctuations are not suppressed by the capacitor C1 and the error amplifier 1. This lowers the effect of suppressing fluctuations in the output voltage Vo and decreases the PSRR. The same problem also occurs in the LDO circuit 200 shown in FIG. 4.

Japanese Laid-Open Patent Publication No. 2001-159922 and in Japanese Laid-Open Patent Publication No. 2002-112535 do not solve the above problems. Therefore, the PSRR characteristic of the LDO circuit cannot be improved.

The present invention provides an LDO circuit for generating a stable constant voltage regardless of fluctuations in the input voltage.

One aspect of the present invention is a linear regulator circuit for generating an output voltage from an input voltage. The linear regulator circuit is provided with an output transistor including a first terminal for receiving the input voltage, a second terminal for outputting the output voltage, and a control terminal. An error amplifier is powered by the input voltage and includes a first input terminal for receiving the output voltage, a second terminal for receiving a reference voltage, and an output terminal. The error amplifier generates a control voltage for controlling the output transistor based on a voltage difference between the output voltage and the reference voltage and supplies the control voltage to the output terminal. A first capacitor and a resistor are connected in series between the first terminal of the output transistor and the output terminal of the error amplifier.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic circuit diagram of an LDO circuit in the prior art;

FIG. 2 is a schematic circuit diagram of the error amplifier shown in FIG. 1;

FIG. 3 is a schematic circuit diagram of another LDO circuit in the prior art;

FIG. 4 is a schematic circuit diagram of the error amplifier and the reverse phase amplifier of FIG. 3;

FIG. 5 is a schematic circuit diagram of an LDO circuit according to a first embodiment of the present invention;

FIG. 6 is a schematic circuit diagram of the error amplifier and the buffer circuit shown in FIG. 5;

FIG. 7 is a schematic circuit diagram of a simulation circuit for analyzing the operation of the LDO circuit shown in FIGS. 5 and 6;

FIG. 8 is a graph showing the PSRR characteristic and the gain of the LDO circuit shown in FIG. 5, the graph showing the results when simulating the operation of the LDO circuit with the simulation circuit of FIG. 7;

FIG. 9 is a graph showing a phase margin of the LDO circuit of FIG. 5, the graph showing the results when simulating the operation of the LDO circuit with the simulation circuit of FIG. 7;

FIG. 10 is a schematic circuit diagram of an LDO circuit according to a second embodiment of the present invention; and

FIG. 11 is a schematic circuit diagram of the error amplifier shown in FIG. 10.

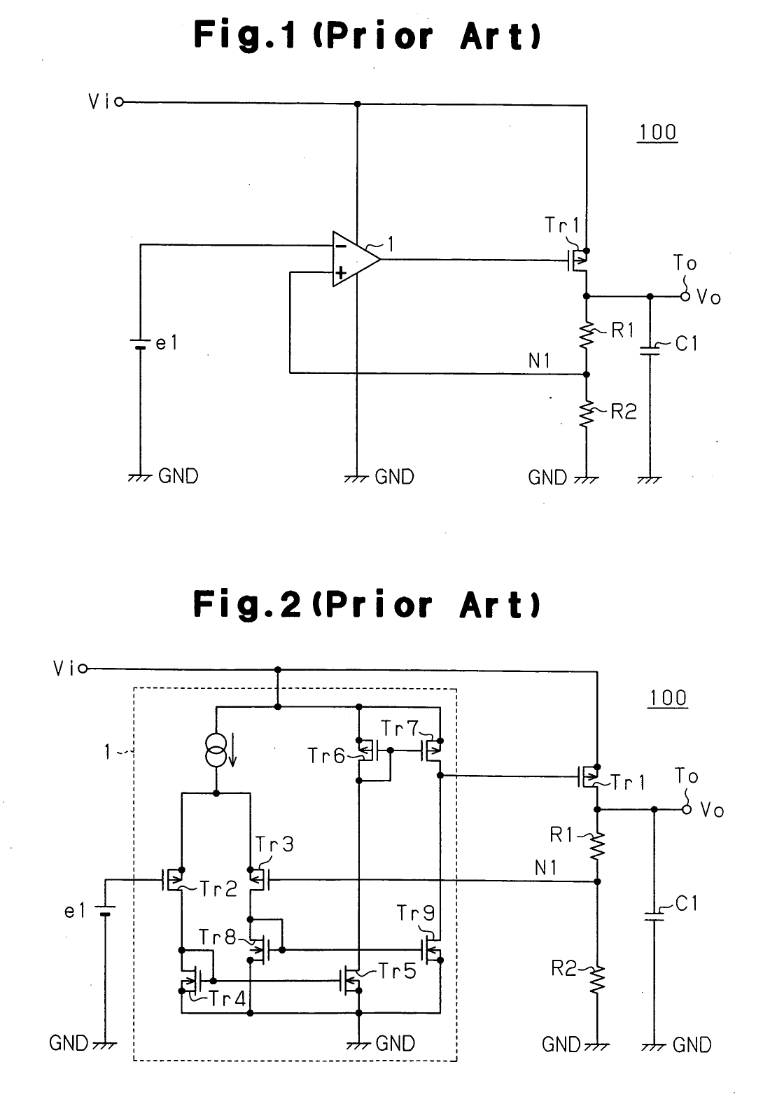

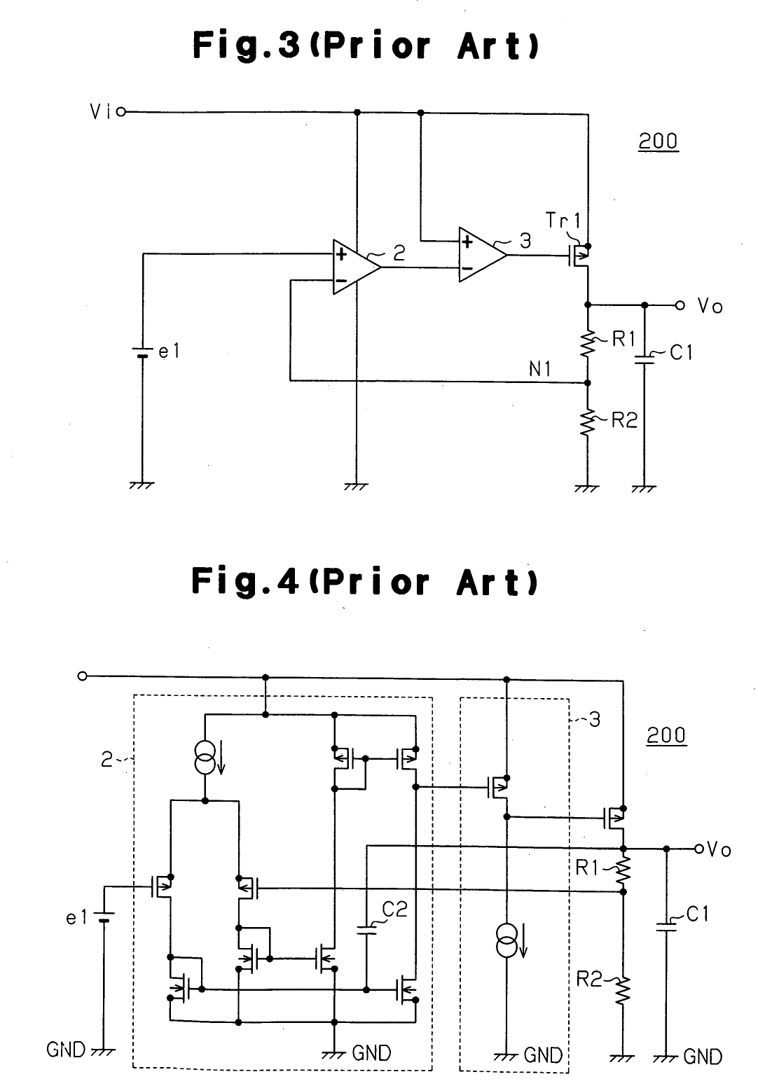

### DETAILED DESCRIPTION OF THE PREFERRED EMBODIMENTS

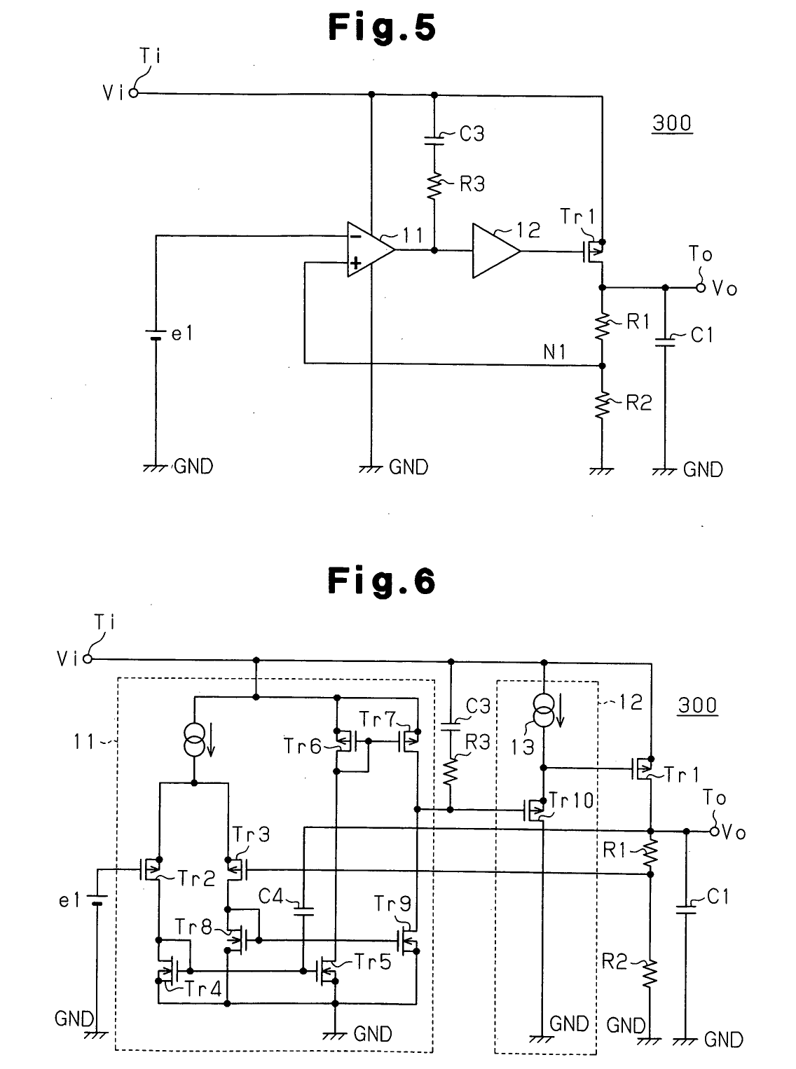

FIG. 5 is a schematic circuit diagram of an LDO circuit 300 according to a first embodiment of the present invention. In the first embodiment, the output signal of an error amplifier 11 is provided to the gate (control terminal) of an output transistor Tr1 via a buffer circuit 12. A capacitor (first capacitor) C3 and a resistor R3 are connected in series between the source (first terminal) of the output transistor Tr1 that receives the input voltage Vi and the output terminal of the error amplifier 11.

The buffer circuit 12 stably provides the output signal of the error amplifier 11 to the gate of the output transistor Tr1. Accordingly, the buffer circuit 12 has a gain of one.

Resistors R1 and R2 are connected in series between the drain (second terminal) of the output transistor Tr1 and ground GND. Node N1 located between the resistors R1 and R2 is connected to the positive input terminal (first input terminal) of the error amplifier 11. The reference voltage e1 is supplied to the negative input terminal (second input terminal) of the error amplifier 11.

Output voltage Vo is output to an output terminal To, which is connected to the drain of the output transistor Tr1, and to a capacitor (second capacitor) C1, which is connected between the output terminal To and the ground GND.

In such a configuration, when the output voltage Vo decreases and the potential at node N1 decreases, the error amplifier 11 functions to decrease the gate voltage (control voltage) of the output transistor Tr1. This decreases the on-resistance of the output transistor Tr1 and increases the output voltage Vo. When the output voltage Vo increases and the potential at node N1 increases, the error amplifier 11 functions to increase the gate voltage of the output transistor Tr1. This increases the on-resistance of the output transistor Tr1 and decreases the output voltage Vo.

The reference voltage e1 is set so that the output transistor Tr1 functions in a small on-resistance range. The capacitor C1 suppresses fluctuations in the output voltage Vo caused by a load connected to the output terminal To.

In such a configuration, the error amplifier 11 and the capacitor C1 suppressed fluctuations in the output voltage Vo, and the output voltage Vo is generated so that the voltage decrease from the input voltage Vi becomes small. The error amplifier 11 functions to suppress low frequency fluctuations in the output voltage Vo, and the capacitor C1 functions to suppress high frequency fluctuations in the output voltage Vo.

FIG. 6 is a schematic circuit diagram of the error amplifier 11 and the buffer circuit 12 shown in FIG. 5. The error amplifier 11 includes a capacitor C4 in addition to the devices of the error amplifier 1 shown in FIG. 2.

The reference voltage e1 and the potential at node N1 are supplied to input transistors Tr2 and Tr3 of the error amplifier 11, respectively. Transistors Tr4 and Tr5 function as a current mirror based on the drain current of the transistor Tr2. Transistors Tr6 and Tr7 function as a current mirror based on the drain current of the transistor Tr5.

Further, transistors Tr8 and Tr9 function as a current mirror based on the drain current of the transistor Tr3. The drain of each of the transistors Tr7 and Tr9 is connected to the gate of a transistor Tr10 in the buffer circuit 12.

The transistor Tr10 is configured by a P-channel MOS transistor, which has a source connected to a constant current supply 13, a drain connected to the ground GND, and a source is connected to the gate of the output transistor Tr1. The capacitor C4 is connected between the output terminal To and the gates of the transistors Tr4 and Tr5. The capacitor C4 suppresses high frequency fluctuations in the output voltage Vo and improves the response of the error amplifier 11 in the same manner as the capacitor C2 shown in FIG. 4.

In such a configuration, the current mirror operations, which is based on the reference voltage e1 and performed by the transistors Tr4, Tr5, Tr6, and Tr7, decrease the drain current of the transistor Tr7 as the potential at node N1 decreases and increases the drain current of the transistor Tr7 as the potential at node N1 decreases. Further, the drain current of the transistor Tr9 increases as the potential at node N1 decreases and decreases as the potential at node N1 increases.

Accordingly, the error amplifier 11 functions as a positive phase amplifier that increases the gate potential of the output transistor Tr1 as the output voltage Vo increases and decreases the gate potential of the output transistor Tr1 as the output voltage Vo decreases.

The capacitor C4 suppresses high frequency fluctuations in the output voltage Vo and improves the response of the error amplifier 11.

The operation of the LDO circuit 300 including the capacitor C3 and the resistor R3 will now be described.

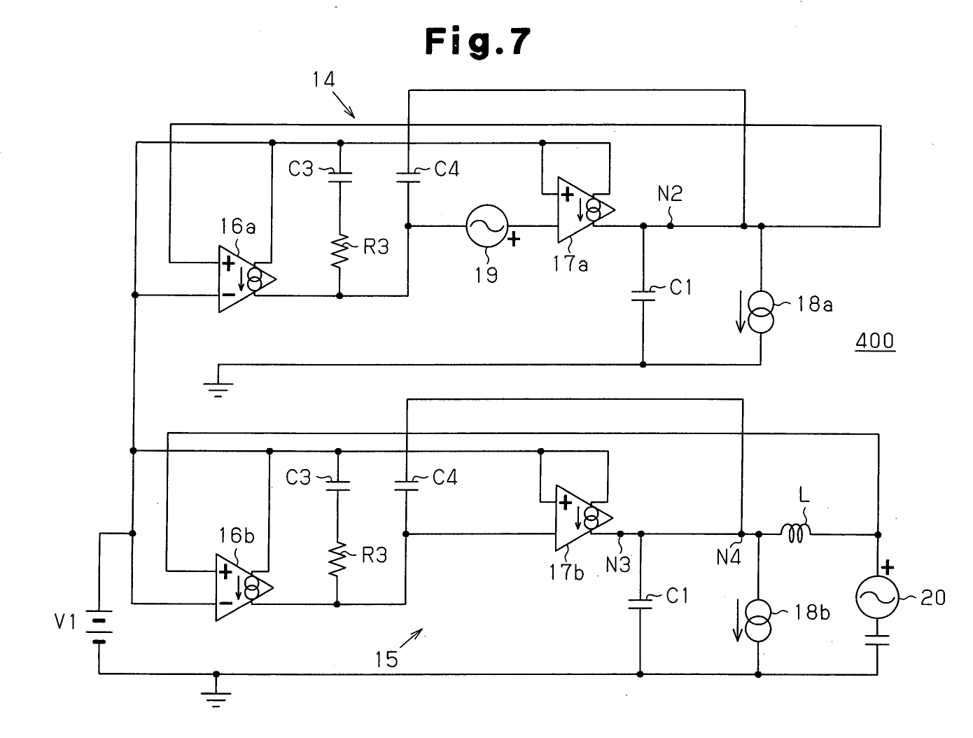

FIG. 7 is a schematic circuit diagram-of a simulation circuit 400 for analyzing the operation of the LDO circuit 300 shown in FIGS. 5 and 6. The simulation circuit 400 includes a first circuit 14 for analyzing the PSRR and a second circuit 15 for analyzing the phase characteristic.

The first circuit 14 includes an amplifier 16a corresponding to the error amplifier 11, an amplifier 17a corresponding to the output transistor Tr1, and a current supply 18a. The second circuit 15 includes an amplifier 16b corresponding to the error amplifier 11, an amplifier 17b corresponding to the output transistor Tr1, and a current supply 18b. Power supply voltage V1 is supplied to each of the amplifiers 16a, 16b, 17a, and 17b. The current that flows to the current supplies 18a and 18b is a load current that flows to the output terminal To.

The amplifier 17a in the first circuit 14 is connected to a signal source 19 and provided with an AC signal, which corresponds to a fluctuation in the input voltage Vi. The PSRR characteristic is detected at node N2, which is the output terminal of the amplifier 17a.

The output terminal of the amplifier 17b in the second circuit 15 is connected to the amplifier 16b by an inductance L. The inductance L is a device for performing a simulation and is set to a high inductance value of, for example 1 kH. The inductance L cuts out AC components from the output signal of the amplifier 17b.

The input terminal of the amplifier 16b is connected to a signal source 20 and provided with an AC signal. The phase and the gain are each detected at nodes N3 and N4, which are the output terminal of the amplifier 17b.

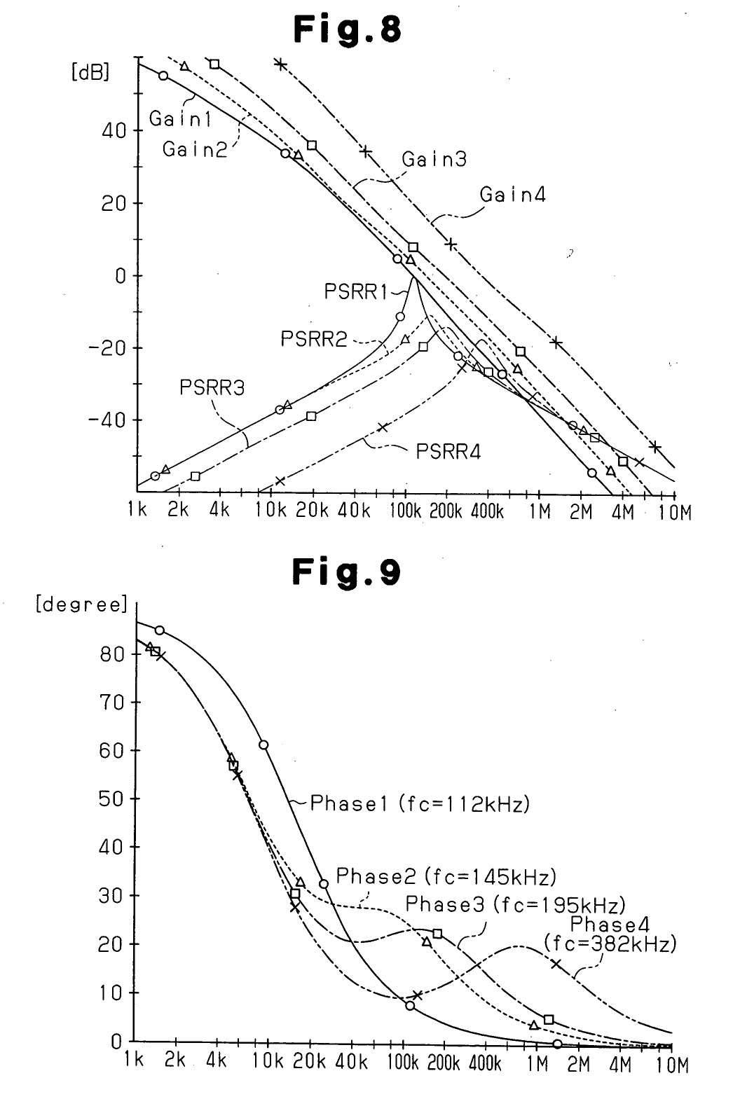

FIG. 8 is a graph showing the PSRR characteristic and the gain of the LDO circuit 300. The graph shows the results of four simulation cases, which are illustrated in table 1, performed on the LDO circuit 300 by the simulation circuit 400. FIG. 9 is a graph showing the phase characteristic of the LDO circuit 300 obtained in the simulations.

TABLE 1

| | | | | | Phase | |
|---|---|---|---|---|---|---|
| | | | | fc | margin | PSRR |
| | C4 | C3 | R3 | [kHz] | [deg] | [dB] |
| Case 1 | 2 pF | 0 pF | −Ω | 112 | 8.1 | −0.04 |
| Case 2 | 1 pF | 1 pF | 3 MΩ | 145 | 21.1 | −10.8 |
| Case 3 | 0.5 pF | 0.5 pF | 3 MΩ | 195 | 22.2 | −13.7 |
| Case 4 | 0.1 pF | 0.1 pF | 3 MΩ | 382 | 17.3 | −17.2 |

As shown in table 1, the capacitors C3 and C4 and the resistor R3 were changed to four different values in each of the four simulation cases 1 to 4. Case 1 corresponds to the prior art example (FIG. 4). More specifically, the value of the capacitor C3 is 0, and the value of the resistor R3 is infinite. In case 1, the value of the capacitor C4 (corresponding to capacitor C2 of FIG. 4) is set to 2 pF.

In case 2, the sum of the values of the capacitors C4 and C3 is set to be equal to the value of the capacitor C4 of case 1, and the value of the resistor R3 is set to 3 MΩ. In case 3, the values of the capacitors C4 and C3 are each set to 0.5 pF, and the value of the resistor R3 is set to 3 MΩ. In case 4, the values of the capacitors C4 and C3 are each set to 0.1 pF, and the value of the resistor R3 is set to 3 MΩ.

Further, in table 1, fc indicates the frequency when the gain is zero, the phase margin indicates the phase characteristic for fc, or a margin for the oscillation of the amplifier 17a, and PSRR indicates the maximum value of the PSRR in the vicinity of fc.

In FIG. 9, phases 1 to 4 and gains 1 to 4 respectively correspond to cases 1 to 4. In FIG. 8, PSRR 1 to 4 respectively correspond to cases 1 to 4.

As shown in table 1, the phase margin is low and the PSRR value is not satisfactory (i.e., PSRR 1 of FIG. 8 has a high peak value) for fc in case 1. In case 2, the PSRR at a low frequency is substantially the same as that in case 1. However, the phase margin and the peak value of PSRR are significantly improved compared to case 1.

Since fc is high in cases 3 and 4, the peak value of PSRR is further improved compared to cases 1 and 2. The phase margin is substantially the same as that in case 2. Further, the PSRR value at the low frequency band is significantly improved compared to cases 1 and 2. That is, the band of the PSRR characteristic of the error amplifier 11 is broadened to the low frequency region.

The optimal value of the resistor R3 is obtained through the equation of R3=1/(2nfc·Cs), where Cs represents the series-connected capacitance value of the capacitors C3 and C4.

The LDO circuit 300 of the first embodiment has the advantages described below.

(1) The capacitor C3 and the resistor R3, which are connected in series between the source of the transistor Tr1 receiving the input voltage Vi and the output terminal of the error amplifier 11, suppress the peak value of the PSRR characteristic. This suppresses fluctuations in the output voltage Vo caused by fluctuations in the input voltage Vi.

(2) The band of the PSRR characteristic is broadened by the capacitor C3 and the resistor R3, which are connected in series between the source of the transistor Tr1 receiving the input voltage Vi and the output terminal of the error amplifier 11. This, in particular, improves the PSRR characteristic at the low frequency region.

(3) The PSRR characteristic is improved by a simple configuration in which the capacitor C3 and the resistor R3 are just added.

(4) The PSRR characteristic is further improved by connecting the capacitor C3, for constant current driving the output transistor Tr1, in the vicinity of the source of the output transistor Tr1.

(5) The PSRR characteristic having a low peak value over the entire frequency bands is obtained by setting the frequency band determined by C3 and R3 to be higher than the frequency band determined by gm/C1, where gm represents the conductance of the output transistor Tr1.

(6) Phase delays are alleviated by the resistor R3 and the phase margin being increased to prevent the output voltage Vo from oscillating. Accordingly, the band of the PSRR characteristic of the error amplifier 11 is broadened.

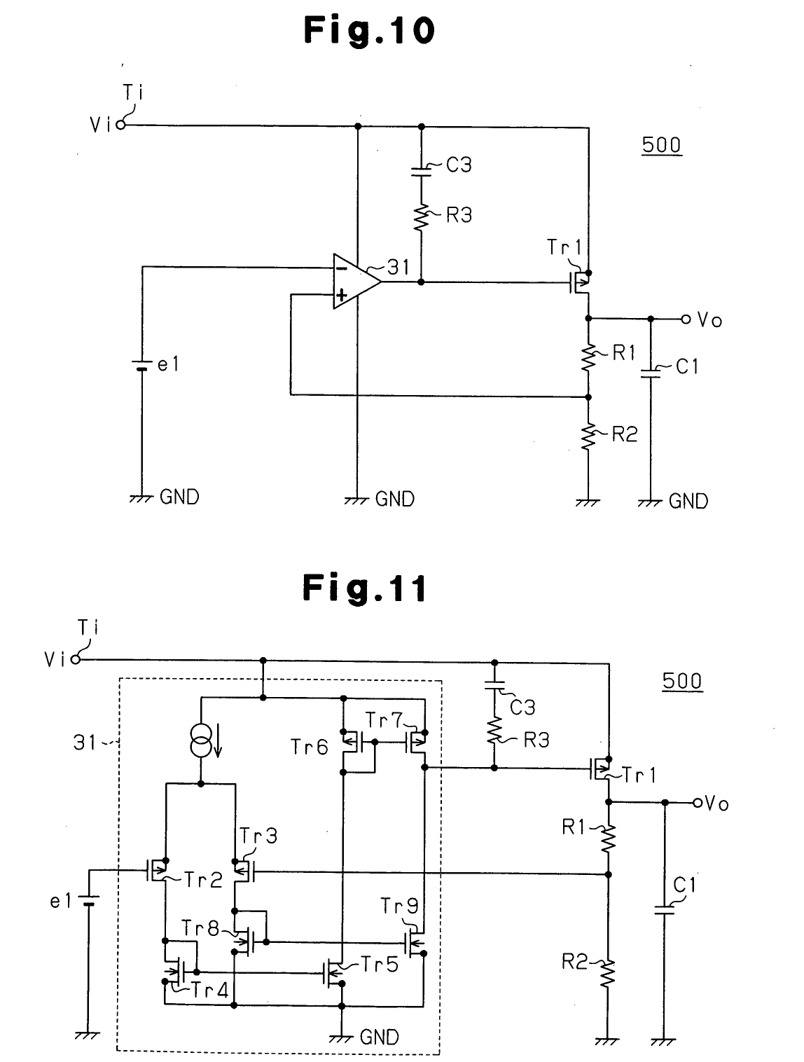

FIG. 10 is a schematic circuit diagram of an LDO circuit 500 according to a second embodiment of the present invention. The output signal of the error amplifier 31 is directly provided to the gate of the output transistor Tr1 in the LDO circuit 500 of the second embodiment.

FIG. 11 is schematic circuit diagram of the error amplifier 31 shown in FIG. 10. The error amplifier 31 does not include the capacitor C4 of the error amplifier 11 in the first embodiment.

In the error amplifier 31, a sufficient current driving capacity is ensured for the transistors Tr7 and Tr9 of the error amplifier 31 with respect to the gate capacitance of the output transistor Tr1. As a result, the buffer circuit 12 of the first embodiment becomes unnecessary.

In such a configuration, the LDO circuit 500 of the second embodiment has the same advantages as the first embodiment.

It should be apparent to those skilled in the art that the present invention may be embodied in many other specific forms without departing from the spirit or scope of the invention. Particularly, it should be understood that the present invention may be embodied in the following forms.

The output transistor Tr1 is not necessarily limited to a MOS transistor in the first and second embodiments.

The capacitor C4 may be omitted in the first embodiment.

The values of the capacitor C3, the capacitor C4, and the resistor R3 are not limited to the values shown in table 1 in the first embodiment.

The present examples and embodiments are to be considered as illustrative and not restrictive, and the invention is not to be limited to the details given herein, but may be modified within the scope and equivalence of the appended claims.

What is claimed is:

1. A linear regulator circuit for generating an output voltage from an input voltage, the linear regulator circuit comprising:
an output transistor including a first terminal for receiving the input voltage, a second terminal for outputting the output voltage, and a control terminal;
an error amplifier powered by the input voltage and including a first input terminal for receiving the output voltage, a second terminal for receiving a reference voltage, and an output terminal, wherein the error amplifier generates a control voltage for controlling the output transistor based on a voltage difference between the output voltage and the reference voltage and supplies the control voltage to the output terminal; and
a first capacitor and a resistor connected in series between the first terminal of the output transistor and the output terminal of the error amplifier.

2. The linear regulator circuit according to claim 1, further comprising:
a buffer circuit, connected between the output terminal of the error amplifier and the control terminal of the output transistor, for receiving the control voltage from the error amplifier and supplying the control voltage to the control terminal of the output transistor.

3. The linear regulator circuit according to claim 1, wherein the error amplifier directly supplies the control voltage to the control terminal of the output transistor.

4. The linear regulator circuit according to claim 1, wherein the first capacitor is directly connected to the first terminal of the output transistor.

5. The linear regulator circuit according to claim 1, further comprising:
a second capacitor connected to the second terminal of the output transistor, wherein the output transistor has a predetermined conductance, and a frequency band set by the first capacitor and the resistor is higher than a frequency band set by the conductance of the output transistor and the second capacitor.

6. The linear regulator circuit according to claim 1, wherein the output transistor is configured by an MOS transistor, and the MOS transistor includes a source functioning as the first terminal, a drain functioning as the second terminal, and a gate functioning as the control terminal.

7. The linear regulator circuit according to claim 1, further comprising:
a third capacitor, connected between the error amplifier and the second terminal of the output transistor, for suppressing fluctuation in the output voltage.

8. The linear regulator circuit according to claim 7, wherein the value of the resistor is determined based on the first capacitor and the third capacitor.
